(19) United States
(12) Patent Application Publication
(10) Pub. No.: US 2004/0228487 A1
(43) Pub. Date: Nov. 18, 2004

(54) Content reading apparatus

(76) Inventors: Shigenori Maeda, Katano-shi (JP); Norio Nakamura, Ikoma-gun (JP); Takanori Senoh, Hirakata-shi (JP); Shunji Harada, Osaka-shi (JP); Kazuya Fujimura, Ikoma-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/482,969

(22) PCT Filed: Jul. 9, 2002
(86) PCT No.: PCT/JP02/06943

(30) Foreign Application Priority Data
Jul. 9, 2001 (JP) 2001-207483

(51) Int. Cl. H04N 7/167; G06F 12/14

(52) U.S. Cl. 380/232; 713/193

(57) ABSTRACT

A content reading apparatus only permits the use of contents such as images, music, and the like within a permitted usage period. In a recording medium having an authentication function, secure data that includes a decryption key and a remaining usage period is recorded in a protected area, and an encrypted content corresponding to the secure data is recorded in a user area. A decrypting of the encrypted content by a decryption unit, and an outputting of the decrypted content by an output unit to a user is only permitted for the duration that the usage rights judgment unit judges the remaining usage period to be greater than zero. The remaining usage period is updated by the usage rights judgment unit in accordance with a usage period of the content by the user and rewritten back into the protected area.

### TECHNICAL FIELD

The present invention relates generally to an apparatus for reading contents such as image information and audio information recorded on a recording medium, and particularly to a content reading apparatus for controlling the permitted usage of contents.

### BACKGROUND ART

The popularization of the Internet and broadband networks in recent years has resulted in the mass distribution, both free or otherwise, of images, music, and other digital information. Such digital information can be downloaded and recorded onto any of a variety of recording mediums, after which the recorded digital information can be freely handled. In other words, in an environment in which, for instance, connection to a network or reception of a broadcast is possible, a user can obtain desired digital information from the network or broadcast during prescribed time periods, record the obtained digital information onto a recording medium, and then use the recorded digital information freely without the restrictions imposed by environment and time. Storing digital information on a recording medium in this way is very convenient because it allows for the digital information to be used in many different environments and by many different apparatuses. However, since copies of the digital information that are equal in quality to the original can be easily made, use of the digital information is preconditioned on being able to prevent unauthorized copying so as to protect the copyright of the digital information.

Copyright protection for digital information recorded on a recording medium is generally provided by encrypting the digital information and ensuring that only legitimate users are able to decrypt the encrypted digital information. Since third parties are not able to read the encrypted digital information from the recording medium, it is possible to use conventional recording mediums to record the encrypted digital information. However, since information (a decryption key) required to decrypt the encrypted digital information must be kept from unauthorized third parties, it is imperative that the encrypted digital information be stored on a recording medium capable of protecting the encrypted digital information from being read by an unauthorized apparatus.

As such, recording mediums have been developed in recent years that include both a readily accessible area (i.e. user area) for recording encrypted digital information, and a protected area for storing the decryption key. This type of recording medium conducts processing to authenticate an apparatus to which the recording medium is connected, and the apparatus is only able to access (i.e. read/write) the protected area if authenticated. By recording the decryption key in the protected area, the encrypted digital information and the decryption key can be managed together on the same recording medium without unauthorized third parties being able to obtain the decryption key.

When usage rights relating to digital information are obtained through a contract with the copyright holder, it is not always required that the user purchase the digital information; that is, it is not always required that the user be in possession of the usage rights forever. For example, when usage rights are obtained for digital information such as a rental video having a usage period restriction of, say, one week, the user benefits from being able to use the digital information for less than the purchase cost. However, conventional recording methods for recording mediums having an authorization function only permit contracts for the purchase of digital information, and cannot record information relating to usage period restrictions.

As mentioned above, access to the protected area is only permitted to those apparatuses that clear the authorization process. A controller is provided in the recording medium to control this process. Thus, in comparison to the user area, which can be accessed without authentication, accessing the protected area requires excess processing time to conduct the authentication processing and excess power to operate the controller. As such, a conventional technique for reducing the number of times the protected area needs to be accessed is to store voluminous encrypted digital information in the user area, and comparatively compact information such as decryption keys as well as other important information in the protected area.

To realize usage period controls, remaining usage period information needs to be managed. Information such this, which must be protected from tampering by a user, should of course be stored in the protected area. For example, if the recording medium is a semiconductor memory card, and the remaining usage period is updated incessantly, particular areas of flash memory will obviously require frequent accessing. Since the lifespan of flash memory is generally considered to be around one hundred thousand rewrites, frequent accessing of the protected area will unduly shorten this limited lifespan, damaging the protected area and making further use of the digital information recorded therein impossible. So as to avoid damaging the protected area, it is preferable not to employ conventional updating methods according to which the updating is conducted incessantly, and to minimize as much as possible the number of times the protected area is accessed for update processing. As such, updating at regular time intervals is considered preferable. Furthermore, it is possible to imagine instances in which the interests of the digital information provider are compromised because of the remaining usage period not being properly updated. For example, a user might suddenly turn off the power supply or disconnect the recording medium immediately before the remaining usage period is to be updated. To counter such malevolent acts by the user, measures are required to ensure that the remaining usage period is reliably updated.

### DISCLOSURE OF THE INVENTION

In view of the issues discussed above, a first object of the present invention is to provide a content reading apparatus, a content reproduction apparatus, a related computer program, and a storage medium for storing the computer program that enable a copyright holder and a user to enter into a contract regarding digital information that requires copyright protection, in which the usage rights are set so as to restrict the usage period of the digital information, as in the case of video/CD rental, for example, and thus no longer require the purchase of the digital information.

A second object of the present invention is to provide a content reading apparatus capable of reliably updating the usage period of the recording medium in a manner that counters any malevolent acts by the user, and thereby prevents the improper usage of contents.

A content reading apparatus provided to achieve the first object includes a content reading unit operable to read a content from a recording medium that has recorded thereon the content and a piece of remaining usage period information showing a remaining usage period of the content, the recording medium including an authentication circuit for authenticating the content reading apparatus when the recording medium is connected thereto, and a protected area in which the remaining usage period information is recorded and which is accessible by the content reading apparatus only when the content reading apparatus has been authenticated by the authentication circuit; a remaining usage period information reading unit operable to read the remaining usage period information from the recording medium; a content output unit operable to output the read content to an external apparatus; and an output termination unit operable to terminate the content output if an elapsed period from a start of the content output is equal to or exceeds the remaining usage period shown in the read remaining usage period information.

The first object may also be achieved by a content reproduction apparatus that includes a content reading unit operable to read a content from a recording medium that has recorded thereon the content and a piece of remaining usage period information showing a remaining usage period of the content, the recording medium including an authentication circuit for authenticating the content reproduction apparatus when the recording medium is connected thereto, and a protected area in which the remaining usage period information is recorded and which is accessible by the content reproduction apparatus only when the content reproduction apparatus has been authenticated by the authentication circuit; a remaining usage period information reading unit operable to read the remaining usage period information from the recording medium; a reproduction unit operable to reproduce the read content; and a reproduction termination unit operable to terminate the content reproduction if an elapsed period from a start of the content reproduction is equal to or exceeds the remaining usage period shown in the read remaining usage period information.

The first object may also be achieved by a computer program for having a content reading apparatus that includes a CPU control a content output, the computer program including a content reading step of reading a content from a recording medium that has recorded thereon the content and a piece of remaining usage period information showing a remaining usage period of the content, the recording medium including an authentication circuit for authenticating the content reading apparatus when the recording medium is connected thereto, and a protected area in which the remaining usage period information is recorded and which is accessible by the content reading apparatus only when the content reading apparatus has been authenticated by the authentication circuit; a remaining usage period information reading step of reading the remaining usage period information from the recording medium; a content output step of outputting the read content to an external apparatus; and an output termination step of terminating the content output if an elapsed period from a start of the content output is equal to or exceeds the remaining usage period shown in the read remaining usage period information.

The first object may furthermore be achieved by a computer-readable storage medium storing a computer program for having a content reading apparatus that includes a CPU control a content output, the computer program including a content reading step of reading a content from a recording medium that has recorded thereon the content and a piece of remaining usage period information showing a remaining usage period of the content, the recording medium including an authentication circuit for authenticating the content reading apparatus when the recording medium is connected thereto, and a protected area in which the remaining usage period information is recorded and which is accessible by the content reading apparatus only when the content reading apparatus has been authenticated by the authentication circuit; a remaining usage period information reading step of reading the remaining usage period information from the recording medium; a content output step of outputting the read content to an external apparatus; and an output termination step of terminating the content output if an elapsed period from a start of the content output is equal to or exceeds the remaining usage period shown in the read remaining usage period information.

According to these structures, the use of content by an apparatus can be restricted to within a predetermined usage period as a result of the remaining usage period information being read from the recording medium by the remaining usage period information reading unit, and the content output being terminated by the output termination unit if the time elapsed from the start of the output is equal to or exceeds the remaining usage period shown in the remaining usage period information. In this way, it is possible to effectively manage usage rights that restrict the usage period of contents.

In order to achieve the second objective of the present invention, the content reading apparatus may further include an update unit operable to update the remaining usage period information so as to show the remaining usage period as being less than the difference between the remaining usage period shown in the remaining usage period information prior to the updating and an output period from the start of the content output until a time of the updating, and the output termination unit may terminate the content output when the elapsed period from the start of the content output is equal to or exceeds the remaining usage period shown in the remaining usage period information prior to the updating.

According to this structure, the remaining usage period information is updated to show a remaining usage period that is shorter than a time period calculated by subtracting the output period up until the time of updating from the remaining usage period shown in the remaining usage period information prior to updating, and output of the content is terminated by the output termination unit if the time elapsed from the start of the output is equal to or exceeds the remaining usage period shown in the remaining usage period information prior to updating. Thus, in addition to restricting the use of content by an apparatus to within a predetermined usage period, this structure allows for the remaining usage period to be updated so as to be shorter than the time period calculated by subtracting the actual usage period from the remaining usage period prior to updating. As a result, the remaining usage period can be reliably updated, even if malevolent acts are attempted by a user, such as suddenly turning off the power supply or disconnecting the recording medium from the content reading apparatus immediately after completing usage of the content.

Here, the update unit may update the remaining usage period information so as to show the remaining usage period as having a zero value, and at a completion of the content output, reupdate the remaining usage period information based on an output period from the start until the completion of the content output.

Here, the update unit may update the remaining usage period information before the completion of a predetermined period of content output so as to show the remaining usage period as the difference between the remaining usage period shown in the remaining usage period information prior to the updating and the predetermined period of content output, and at a completion of the content output, reupdate the remaining usage period information based on an output period from the start until the completion of the content output.

In order to achieve the second object, the content reading apparatus may alternatively include an update unit operable to update the remaining usage period information for every lapse of a predetermined update period so as to show the remaining usage period as being the difference between the remaining usage period shown in the remaining usage period information prior to the updating and the predetermined update period, and the output termination unit may terminate the content output when the elapsed period from the start of the content output is equal to or exceeds the remaining usage period shown in the remaining usage period information prior to the updating.

According to this structure, the remaining usage period information is updated by the update unit at regular predetermined update periods such that the remaining usage period prior to updating is reduced by an amount equal to the update period, and output of the content is terminated by the output termination unit if the time elapsed from the start of the output is equal to or exceeds the remaining usage period shown in the remaining usage period information prior to updating. Thus, in addition to restricting the use of content by an apparatus to within a predetermined usage period, this structure allows for the remaining usage period to be updated so as to be shorter than the time period calculated by subtracting the actual usage period from the remaining usage period prior to updating. As a result, the remaining usage period can be reliably updated, even if malevolent acts are attempted by a user, such as suddenly turning off the power supply or disconnecting the recording medium from the content reading apparatus immediately after completing usage of the content.

Here, the content reading apparatus may further include a termination instruction reception unit operable to receive an instruction from a user to terminate the content output, the output termination unit may terminate the content output when a termination instruction is received by the termination instruction reception unit, even if the elapsed period since the start of the content output is less than the remaining usage period shown in the read remaining usage period information, and the update unit may reupdate, at a time of the reception of the termination instruction from the user, the remaining usage period information based on an output period from the start of the content output until the reception of the termination instruction.

### BRIEF DESCRIPTION OF THE DRAWINGS

FIG. 1A shows an external view of an SD memory card;

FIG. 1B shows layers in the SD memory card;

FIG. 1C shows a physical layer in the SD memory card;

FIG. 2 shows directories and files in a user area and a protected area of the SD memory card;

FIG. 3 is a block diagram of a content reading apparatus according to the embodiments of the present invention;

FIG. 4 is a flowchart of a permitted usage judgment processing operation according to an embodiment 1, the operation being performed by a usage rights judgment unit 15 of the content reading apparatus;

FIG. 5 is a flowchart of a permitted usage judgment processing operation according to an embodiment 2, the operation being performed by usage rights judgment unit 15 of the content reading apparatus; and

FIG. 6 is a flowchart of a permitted usage judgment processing operation according to an embodiment 3, the operation being performed by usage rights judgment unit 15 of the content reading apparatus.

### BEST MODE FOR CARRYING OUT THE INVENTION

Structures Common to the Embodiments of the Present Invention

Recording Medium

Firstly, a recording medium according to the embodiments of the present invention is described with reference to the drawings. An SD memory card has been selected as the recording medium upon which the description will be based. The high level of confidentiality with which secure data can be stored makes an SD memory card ideal for describing the characteristics of the invention.

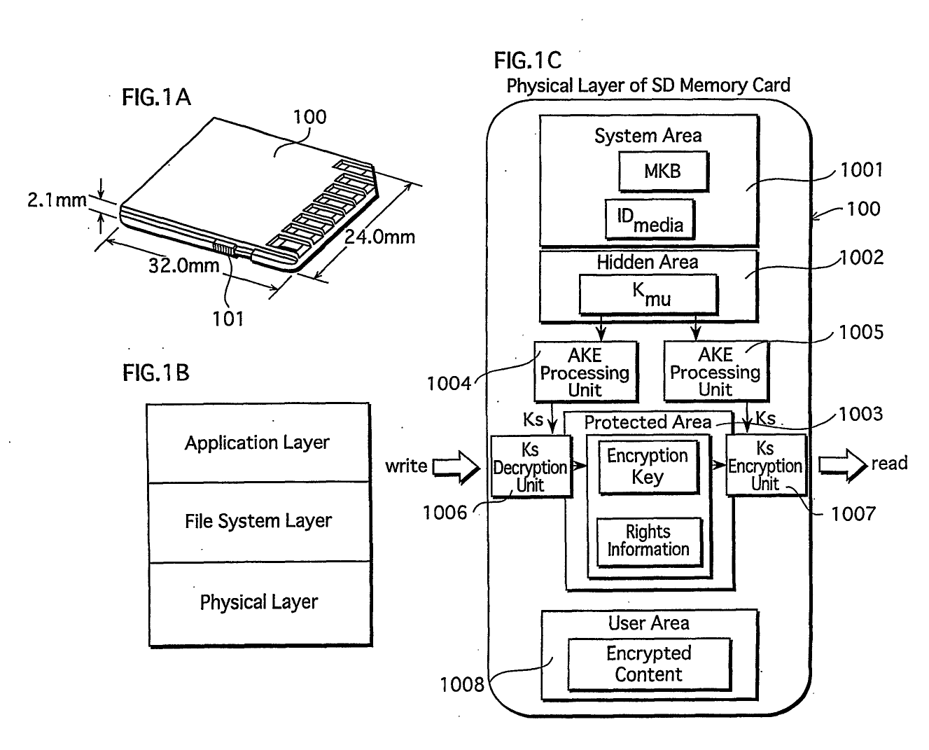

FIG. 1A shows an external view of an SD memory card 100 having a length of 32.0 mm, a width of 24.0 mm, and a thickness of 2.1 mm. This postage stamp size allows SD memory card 100 to be easily handled. SD memory card 100 has nine connectors to facilitate connection with an apparatus, and on a side of SD memory card 100 is provided a protection switch 101 that allows a user to manually determine whether recorded data can or cannot be rewritten.

FIG. 1B shows structural layers of SD memory card 100. As shown in FIG. 1B, SD memory card 100 includes (i) a physical layer in which a plurality of contents is securely stored together with encryption keys and rights information that correspond to the contents, (ii) a file system layer which is accessed based on a file allocation table (FAT), according to which the smallest accessible unit is a cluster, and (iii) an application layer in which an encrypted content comprising a copyrighted work is stored together with secure data.

FIG. 1C shows a structure of the physical layer of SD memory card 100. As shown in FIG. 1C, the physical layer includes a system area 1001, a hidden area 1002, a protected area 1003, an AKE processing unit 1004, an AKE processing unit 1005, a Ks decryption unit 1006, a Ks encryption unit 1007, and a user area 1008.

System area 1001 is a read-only area storing a media key block (MKB), and a media ID, neither of which can be rewritten. An apparatus to which SD memory card 100 is connected is able to obtain an encryption key Kmu by reading the MKB and the media ID and correctly performing a predetermined operation using the read MKB and media ID in combination with a device key Kd belonging to the apparatus.

Hidden area 1002 stores the valid encryption key Kmu, which is the encryption key obtained by the apparatus if the apparatus correctly performs the predetermined operation using the read MKB and media ID and a legitimate device key Kd.

Protected area 1003 is part of a non-volatile memory (e.g. EEPROM) in SD memory card 100, and stores secure data such as encryption keys, rights information, and the like.

Authentication & key exchange (AKE) units 1004 and 1005 conduct a “challenge response” form of mutual authentication between the apparatus and SD memory card 100 in order to mutually authenticate SD memory card 100 and the apparatus. If mutual authentication is not successful, processing is terminated, and if mutual authentication is successful, an encryption key (i.e. session key Ks) is shared between SD memory card 100 and the apparatus.

Ks decryption unit 1006 functions as follows. When encrypted data is sent to SD memory card 100 from an apparatus to which SD memory card 100 is connected, Ks decryption unit 1006 assumes that the encrypted data is secure data encrypted using session key Ks, and uses session key Ks to decrypt the encrypted data. Ks decryption unit 1006 then assumes the secure data obtained as a result of the decryption process to be legitimate, and writes the decrypted secure data into the protected area.

Ks encryption unit 1007 functions as follows. When a command to read secure data is outputted to SD memory card 100 from an apparatus to which SD memory card 100 is connected, Ks encryption unit 1007 uses session key Ks to encrypt the secure data stored in the protected area, and outputs the encrypted secure data to the apparatus that issued the command.

User area 1008 is, like protected area 1003, part of the non-volatile memory (e.g. EEPROM). However, unlike protected area 1003, mutual authentication is not required for an apparatus to access user area 1008. A plurality of encrypted contents is stored in user area 1008. If an encryption key read from protected area 1003 is legitimate, it can be used to decrypt the encrypted contents stored in user area 1008. Since the reading/writing of data in protected area 3 depends on the encryption by Ks encryption unit 1007 and the decryption by Ks decryption unit 1006, protected area 1003 can only be accessed legitimately if an apparatus to which SD memory card 100 is connected conducts the AKE processing correctly.

Next, the structuring of files and directories in SD memory card 100 is described.

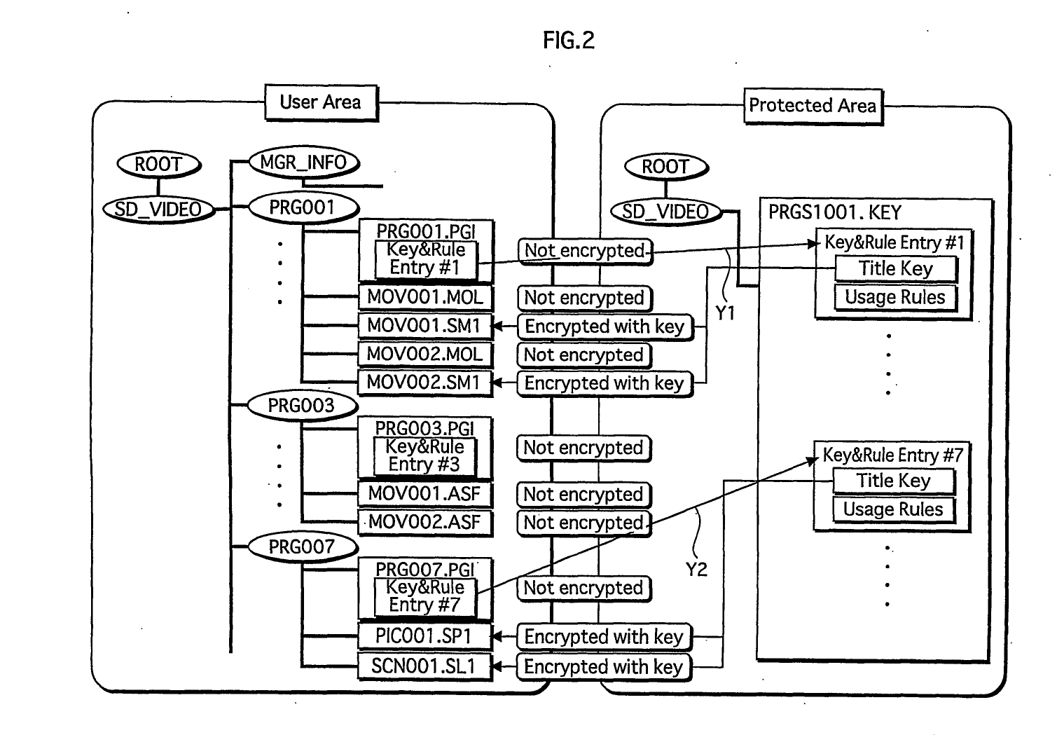

FIG. 2 shows directories and files in user area 1008 and protected area 1003 of the SD memory card. SD memory card 100 is used to record contents distributed by a distribution service. The distributed contents include image data formed from digital data such as movies, still images, and the like.

The directory name “SD_VIDEO” in FIG. 2 shows that the SD memory card 100 is designated for recording image data.

Next, the structure of files and directories in protected area 1003 and user area 1008 is described in detail. As shown in the right half of FIG. 2, the directories in the protected area are structured with a root directory on top, and an SD_VIDEO directory below, and in the SD_VIDEO directory is placed a PRGS1001.KEY file. The structure of directories in the user area is shown in the left half of FIG. 2. In the SD_VIDEO directory of the user area are placed content folders PRG001, . . . , PRG003, . . . , PRG007, and so on. In each content folder is stored various data in file units, this data including management data specifying secure data, a plurality of contents, and data identifying the contents. Specifically, these files include a management file PRG001.PGI, and video data files MOV001.SM1, MOV002.SM1, MOV001.MOL, MOV002.MOL (these files being stored in PRG001), . . . , a management file PRG003.PGI, and video data files MOV001.ASF, MOV002.ASF (these files being stored in PRG003), . . . , a management file PRG007.PGI, and still image data files PIC001.SP1, SCN001.SL1 (these files being stored in PRG007). In FIG. 2, “Encrypted” shows that the data in the corresponding file is in encrypted form, and “Not encrypted” shows that the data in the corresponding file is not in encrypted form. This mixing of encrypted and non-encrypted data results from a consideration of the degree of confidentiality required by each piece of data. For example, MOV001.MOL and MOV002.MOL stored in PRG001 relate to moving image contents, and since they are not encrypted, decryption using a decryption key is not required to reproduce these contents. To give a further example, video data files MOV001.ASF and MOV002.ASF stored in PRG003 are not in encrypted form, and thus decryption using a decryption key is not required to reproduce the contents of these files. Data in the management files is also not in encrypted form.

A structure of the file storing secure data will now be described. The filename of the secure data storage file is PRGS1001.KEY.

As shown in FIG. 2, PRGS1001.KEY is composed of a plurality of Key&Rule Entry areas.

Key&Rule Entry#1, Key&Rule Entry#2, Key&Rule Entry#3, . . . , Key&Rule Entry#7, and soon correspond one-to-one with the content folders recorded in the user area, and are areas of a constant length that have secure data such as encryption keys and rights information corresponding to the contents written therein. Rights information is also referred to as usage rules. The rights information manages the copyright of the content by setting the conditions under which use of the content is permitted. In the embodiments of the present invention, the rights information includes remaining usage period information showing the permitted remaining usage period of the content by an apparatus (described below) to which the SD memory card is connected. The remaining usage period is set as a usage management period shared by the plurality of contents in a content folder. An encryption key is information used to decrypt a corresponding encrypted content that has been targeted for reproduction. Due to the high level of confidentiality required to effectively manage the copyright of contents, the encryption keys and rights information are recorded in encrypted form in Key&Rule Entry areas. To facilitate the encryption process, it is required that the combined length of a single encryption key and a single piece of rights information be constant (e.g. 16 bytes, 32 bytes, 64 bytes), this constant length being determined by the encryption method used. Since the encryption key/rights information combination is required to be of a constant length, each Key&Rule Entry area is also determined so as to be of a constant length.

The numbers (i.e. #1, #2, #3, . . . , #7, and soon) attached to the Key&Rule Entry areas are local numbers within a file. FIG. 2 shows the relationship between the plurality of Key&Rule Entry areas and the plurality of contents (i.e. in a content folder) in the user area. In FIG. 2, arrows Y1 and Y2 show examples of which contents correspond to which Key&Rule Entry area. For example, PRG001 is shown as corresponding to secure data stored in Key&Rule Entry#1 (arrow Y1), and PRG007 is shown as corresponding to secure data stored in Key&Rule Entry#7 (arrow Y2). Thus, each Key&Rule Entry area is set so as to correspond to the plurality of contents stored in each content folder.

Next, the structure of management files (e.g. PRG001.PGI) in the user area is described. A management file shows the correspondence between the content files in the content folders and the Key&Rule Entry areas. Specifically, a management file in a content folder stores data specifying the local number of a Key&Rule Entry area that corresponds to the plurality of contents stored in the content folder, this being achieved by corresponding the number (i.e. 001, 002, and so on) of the content folder with the local number of the Key&Rule Entry area.

In the embodiments, the data in a single file is described as forming a single content. However, it is possible for a plurality of pieces of file data to form a single content.

Content Reading Apparatus

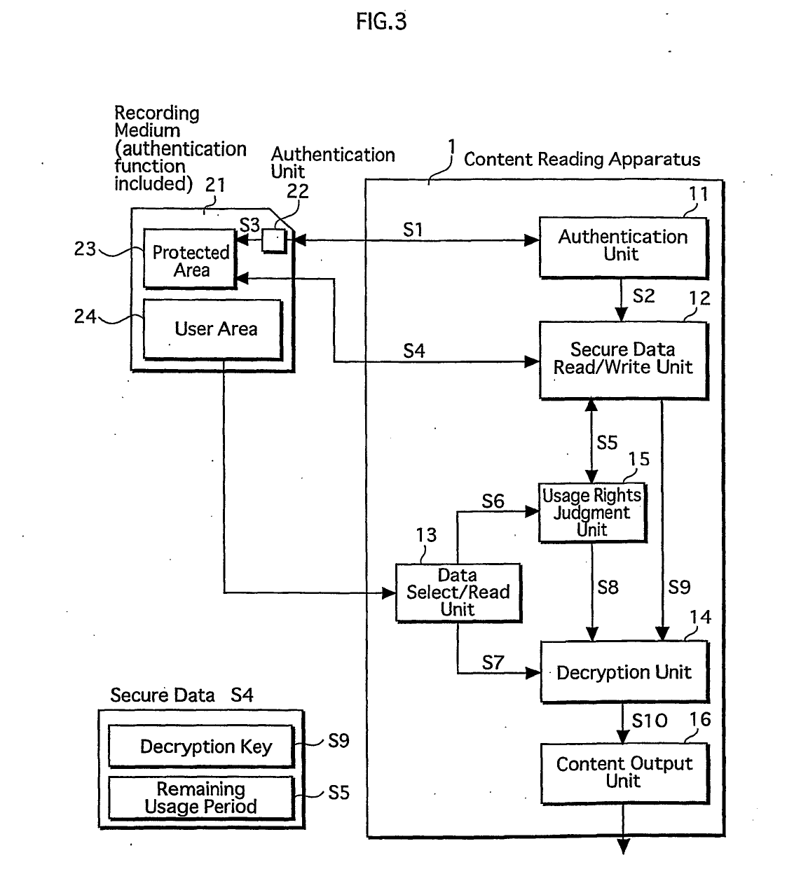

FIG. 3 is a block diagram of a content reading apparatus 1 according to the embodiments of the present invention. As shown in FIG. 3, content reading apparatus 1 includes an authentication unit 11, a secure data read/write unit 12, a data select/read unit 13, a decryption unit 14, a usage rights judgment unit 15, and a content output unit 16.

Content reading apparatus 1 conducts mutual authentication with recording medium 21 in order to verify the legitimacy of the recording medium and the content reading apparatus. The mutual authentication process is conducted using authentication information S1 by authentication unit 11 in the content reading apparatus and an authentication unit 22 in the recording medium. Recording medium 21 is an SD memory card having the structure described above, and authentication unit 22 is formed from hidden area 1002 and AKE processing units 1004 and 1005, and functions to conduct authentication processing with an apparatus to which recording medium 21 is connected. Protected area 23 is the equivalent of protected area 1003, and user area 24 is the equivalent of user area 1008. In the interest of brevity, the various units and areas in FIG. 3 will be referred to below without detailing their respective structures.

If mutual authentication is successfully completed, access lock release signal S3 is sent from authentication unit 22 to protected area 23 in recording medium 21, and secure data read/write lock release signal S2 is sent from authentication unit 11 to secure data read/write unit 12 in content reading apparatus 1, and as a result the reading/writing of secure data S4 by secure data read/write unit 12 becomes possible. Secure data S4 corresponds to a plurality of contents, and includes data such as a decryption key S9 used to decrypt the corresponding encrypted contents, and a remaining usage period S5 showing the remaining time period during which usage of the contents is permitted.

The following example presumes the selection by a user of a content S7 stored in encrypted form. When selected by the user, content S7 is read from user area 24 by data select/read unit 13. The read content S7 is sent from data select/read unit 13 to decryption unit 14, and identification information S6 identifying content S7 is sent to usage rights judgment unit 15. Based on identification information S6, usage rights judgment unit 15 reads remaining usage period S5 of content S7 from protected area 23 via secure data read/write unit 12, and judges whether usage of content S7 is permitted, this judgment being based on whether remaining usage period S5 exceeds a zero value.

If usage of content S7 is judged to be permitted, usage rights judgment unit 15 transmits a usage permission signal S8 to decryption unit 14 for the duration of remaining usage period S5. If usage of content S7 is judged to be not permitted, transmission of usage permission signal S8 is cancelled or immediately terminated. Decryption unit 14 begins decrypting content S7 using decryption key S9 read from protected area 23 via secure data read/write unit 12, the decryption being continued for the duration of usage permission signal S8. A content output unit 16 then begins outputting the decrypted content S10 to an external apparatus (e.g. reproduction apparatus, display apparatus, etc) that will use content S10 (“usage” here includes reproduction, image display, etc).

The output of the content may be conducted in any preferred form, examples of which include the serial output of one pixel of data at a time, or the parallel output of a plurality of pixel data in blocks. Irrespective of the output method used, the output of content S10 will require a certain amount of time. Furthermore, since decryption unit 14 only continues to decrypt content S7 for the duration that usage permission signal S8 is transmitted, it follows that output of decrypted content S10 to the external apparatus by content output unit 16 is also effectively restricted to the duration of usage permission signal S8, this duration being the time period shown in remaining usage period S5.

In the case that content S7 read by data select/read unit 13 is not in encrypted form, usage rights judgment unit 15 still conducts the judgment as described above and transmits usage permission signal S8 to decryption unit 14 for the duration that usage of content S7 is judged to be permitted. Since decryption is not required, decryption unit 14 sends the content (i.e. content S10) to content output unit 16 for the duration of usage permission signal S8, and content output unit 16 outputs content S10 to the external apparatus.

The external apparatus has a display unit for displaying images, and a user interface that has a various keys for receiving instructions from a user relating to commencement/termination of the reproduction. Furthermore, user instructions relating to the reading of specified content from the recording medium and the termination of output to the external apparatus are also performed via key operations.

Described below are various methods according to the present invention of judging whether usage of encrypted content S7 is permitted, as well as various methods of updating the usage period of content S7.

Embodiment 1

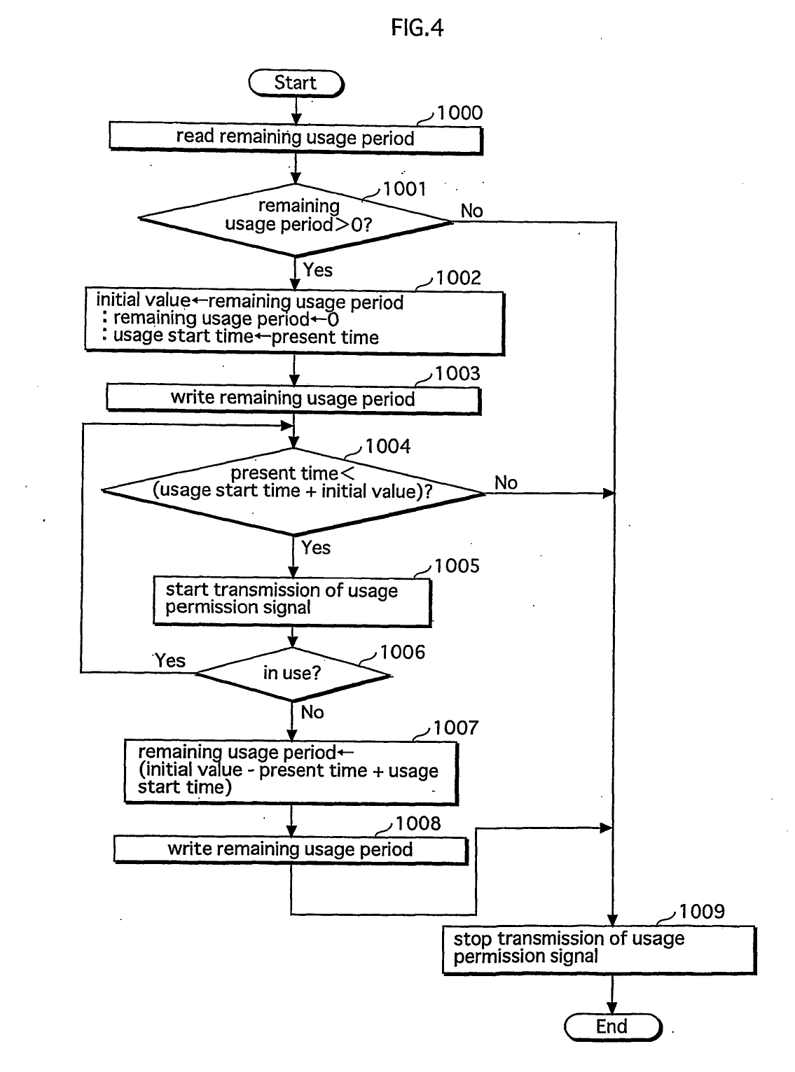

FIG. 4 is a flowchart of a permitted usage judgment processing operation according to an embodiment 1 of the present invention, the operation being performed by usage rights judgment unit 15 (see FIG. 3). As shown in FIG. 4, usage rights judgment unit 15 firstly reads remaining usage period S5 of content S7 from protected area 23 of recording medium 21 via secure data read/write unit 12 (step 1000), and investigates whether remaining usage period S5 is greater than zero (step 1001). If remaining usage period S5 is less than or equal to zero (step 1001=“No”), usage rights judgment unit 15 judges usage to be not permitted, and if usage permission signal S8 (see FIG. 3) is currently being transmitted, usage rights judgment unit 15 terminates transmission of the signal (step 1009) and ends the processing.

If remaining usage period S5 is greater than zero (step 1001=“Yes”), usage rights judgment unit 15 saves remaining usage period S5 in a main memory area of the CPU as initial value z1, sets remaining usage period S5 to zero, obtains the present time, and saves the present time in the main memory area of the CPU as usage start time t1 (step 1002). Usage rights judgment unit 15 then immediately writes remaining usage period S5 set to zero back into protected area 23 via secure data read/write unit 12 (step 1003).

Next, usage rights judgment unit 15 again obtains the present time (t2), calculates a time t3 by adding initial value z1 to usage start time t1, and compares t2 to t3 in order to investigate whether t2 has reached t3 (step 1004). If t2 is equal to or exceeds t3 (step 1004=“No”), usage rights judgment unit 15 judges that usage is not permitted, and if usage permission signal S8 is currently being transmitted, usage rights judgment unit 15 terminates transmission of the signal (step 1009) and ends the processing. If t2 is yet to reach t3 (step 1004=“Yes”), usage rights judgment unit 15 judges that usage is permitted, and if usage permission signal S8 is not currently being transmitted, usage rights judgment unit 15 commences transmission of the signal (step 1005).

Next, usage rights judgment unit 15 investigates whether the user has elected to terminate usage of content S7 by operating a reproduction stop key (step 1006). If usage is still being continued, usage rights judgment unit 15 returns to step 1004. If usage has been terminated, usage rights judgment unit 15 obtains the present time (t4), calculates an elapsed period z2 as the period elapsed between usage start time t1 and present time t4, and sets remaining usage period S5 to the result of initial value z1 minus elapsed period z2 (step 1007). Usage rights judgment unit 15 then rewrites remaining usage period S5 back into protected area 23 via secure data read/write unit 12 (step 1008), terminates transmission of usage permission signal S8 (1009), and ends the processing.

Embodiment 2

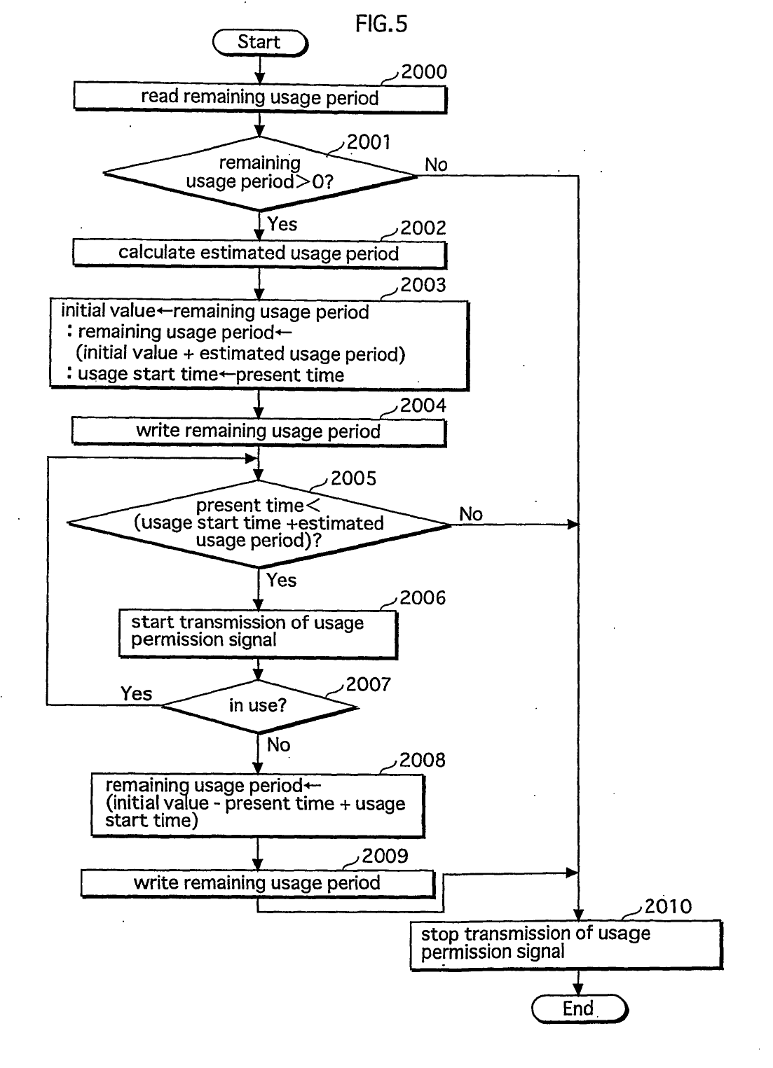

FIG. 5 is a flowchart of a permitted usage judgment processing operation according to an embodiment 2 of the present invention, the operation being performed by usage rights judgment unit 15. As shown in FIG. 5, usage rights judgment unit 15 firstly reads remaining usage period S5 of content S7 from protected area 23 of recording medium 21 via secure data read/write unit 12 (step 2000), and investigates whether remaining usage period S5 is greater than zero (step 2001). If remaining usage period S5 is less than or equal to zero (step 2001=“No”), usage rights judgment unit 15 judges usage to be not permitted, and if usage permission signal S8 is currently being transmitted, usage rights judgment unit 15 terminates transmission of the signal (step 2010) and ends the processing.

If remaining usage period S5 is greater than zero (step 2001=“Yes”), usage rights judgment unit 15 calculates an estimated usage period z3 based on an attribute of encrypted content S7 (step 2002). For example, if content S7 is encrypted image information, estimated usage period z3 may be a reproduction period of the image information.

Next, usage rights judgment unit 15 saves remaining usage period S5 in the main memory area of the CPU as initial value z4, sets remaining usage period S5 to the result of initial value z4 minus estimated usage period z3, obtains the present time, and saves the present time in the main memory area of the CPU as usage start time t5 (step 2003). Usage rights judgment unit 15 then immediately writes the set remaining usage period S5 back into protected area 23 via secure data read/write unit 12 (step 2004).

Next, usage rights judgment unit 15 again obtains the present time (t6), calculates a time t7 by adding estimated usage period z3 to usage start time t5, and compares t6 to t7 in order to investigate whether t6 has reached t7 (step 2005). If t6 is equal to or exceeds t7 (step 2005=“No”), usage rights judgment unit 15 judges that usage is not permitted, and if usage permission signal S8 is currently being transmitted, usage rights judgment unit 15 terminates transmission of the signal (step 2010) and ends the processing. If t6 is yet to reach t7 (step 2005=“Yes”), usage rights judgment unit 15 judges that usage is permitted, and if usage permission signal S8 is not currently being transmitted, usage rights judgment unit 15 commences transmission of the signal (step 2006).

Next, usage rights judgment unit 15 investigates whether the user has elected to terminate usage of content S7 by operating a reproduction stop key (step 2007). If usage is still being continued, usage rights judgment unit 15 returns to step 2005. If usage has been terminated, usage rights judgment unit 15 obtains the present time (t8), calculates an elapsed period z5 as the period elapsed between usage start time t5 and present time t8, and sets remaining usage period S5 to the result of initial value z4 minus elapsed period z5 (step 2008). Usage rights judgment unit 15 then rewrites remaining usage period S5 back into protected area 23 via secure data read/write unit 12 (step 2009), terminates transmission of usage permission signal S8 (2010), and ends the processing.

Embodiment 3

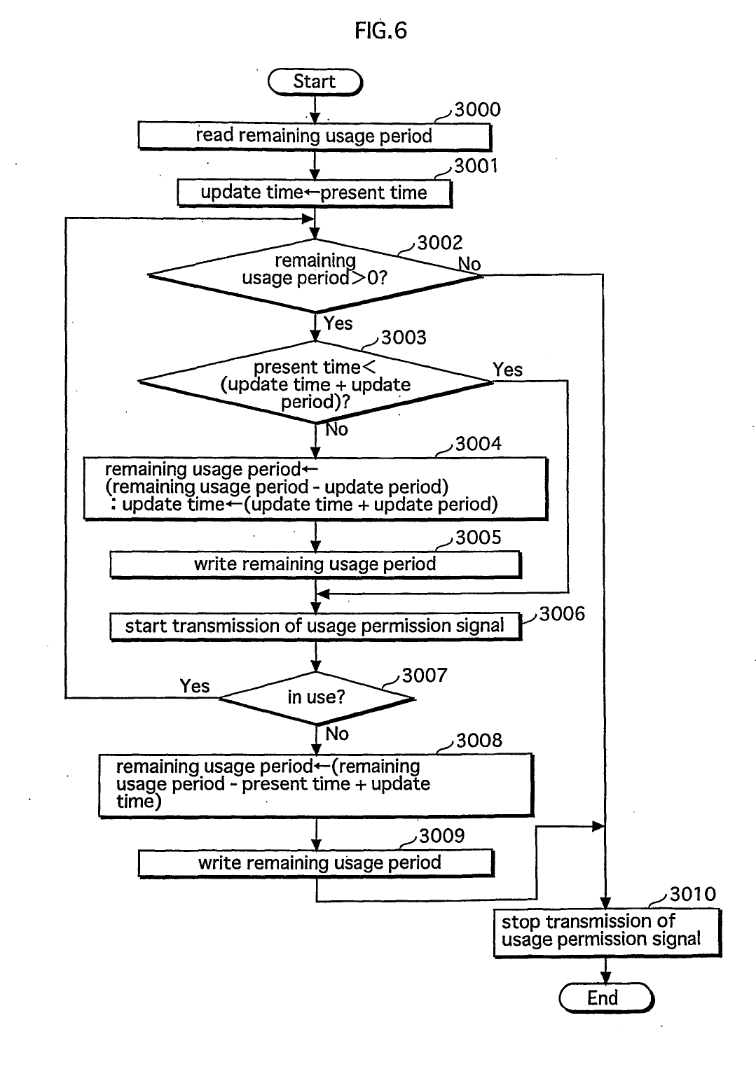

FIG. 6 is a flowchart of a permitted usage judgment processing operation according to an embodiment 3 of the present invention, the operation being performed by usage rights judgment unit 15. As shown in FIG. 6, usage rights judgment unit 15 firstly reads remaining usage period S5 of content S7 from protected area 23 of recording medium 21 via secure data read/write unit 12 (step 3000), obtains the present time, and saves the present time in the main memory area of the CPU as update time t9 (step 3001).

Usage rights judgment unit 15 then investigates whether remaining usage period S5 is greater than zero (step 3002). If remaining usage period S5 is less than or equal to zero (step 3002=“No”), usage rights judgment unit 15 judges usage to be not permitted, and if usage permission signal S8 is currently being transmitted, usage rights judgment unit 15 terminates transmission of the signal (step 3010) and ends the processing. If remaining usage period S5 is greater than zero (step 3002=“Yes”), usage rights judgment unit 15 again obtains the present time (t10) and calculates a time t11 (i.e. “next update time”) by adding a predetermined update period z6 to update time t9, and compares t10 to t11 in order to investigate whether t10 has reached t11 (step 3003). If t10 is yet to reach t11 (step 3003=“Yes”), usage rights judgment unit 15 judges that usage is permitted, and if usage permission signal S8 is not currently being transmitted, usage rights judgment unit 15 commences transmission of the signal (step 3006).

If t10 is equal to or exceeds t11 (step 3003=“No”), usage rights judgment unit 15 subtracts update period z6 from remaining usage period S5, and changes update time t9 to the result of update time t9 plus update period z6 (step 3004). Usage rights judgment unit 15 then rewrites the updated remaining usage period S5 back into protected area 23 (3005), and if usage permission signal S8 is not currently being transmitted, usage rights judgment unit 15 commences transmission of the signal (step 3006).

Next, usage rights judgment unit 15 investigates whether the user has elected to terminate usage of content S7 by operating a reproduction stop key (step 3007). If usage is still being continued, usage rights judgment unit 15 returns to step 3002. If usage has been terminated, usage rights judgment unit 15 obtains the present time (t12), calculates an elapsed period z7 as the period elapsed between the changed update time t9 and present time t12, and sets remaining usage period S5 to the result of remaining usage period S5 minus elapsed period z7 (step 3008). Usage rights judgment unit 15 then rewrites the set remaining usage period S5 back into protected area 23 via secure data read/write unit 12 (step 3009), terminates transmission of usage permission signal S8 (3010), and ends the processing.

According to the embodiments as described above, a remaining usage period and a decryption key are recorded together with encrypted digital information on a recording medium having an authentication function, and as a result the decryption and usage of encrypted contents can be restricted to the duration of a usage period set by the copyright holder. As such, it is possible for a copyright holder and a user to enter into a contract regarding digital information that requires copyright protection, in which the usage rights are set so as to restrict the usage period of the digital information, as in the case of video/CD rental, for example, and thus no longer require the purchase of the digital information.

Furthermore, the secure data read/write unit can be structured to perform any of the following three methods of updating the remaining usage period: 1, the remaining usage period may be set to zero at the usage start time, and then updated at the usage stop time based on the actual usage period; 2, an estimated usage period may be subtracted from the remaining usage period at the usage start time, and the remaining usage period then updated at the usage stop time based on the actual usage period; 3, the remaining usage period may be updated at regular update periods based on the actual usage period at the time of updating. These updating methods allow for the remaining usage period information to be updated to show (i) a time period that is shorter than the difference between the remaining usage period prior to updating and the actual output period of the content up until the time of updating, or (ii) a time period obtained by subtracting a predetermined update period from the remaining usage period every time the predetermined update period elapses. As a result, the remaining usage period can be reliably updated even when malevolent acts are attempted by a user, such as suddenly turning off the power supply or disconnecting the recording medium from the content reading apparatus immediately after completing usage of the content. Moreover, because the remaining usage period prior to updating is updated to a time period that is shorter than the time period obtained by subtracting the actual usage period from the original remaining usage period, the type of malevolent acts by the user described above prove to be ineffective. As such, it is possible to avoid the interests of the copyright holder being compromised by the usage period of the copyrighted digital information being extended without authorization.

Variations

The present invention is, of course, not limited to the embodiments described above. Variations of the embodiments are permissible so long as they remain within the technical scope of the invention. Exemplary variations (1) to (8) are given below.

(1) In the above embodiments, the content is described as being image data. However, usage restriction controls on the remaining usage period may alternatively be conducted with respect to the content being a publication, audio data, and the like.

(2) In the above embodiments, a single remaining usage period is described as corresponds to a single content folder storing a plurality of contents. However, a single remaining usage period may be set to correspond to a plurality of content folders, or a plurality of remaining usage periods may be set to correspond one-to-one with a plurality of contents in a content folder.

(3) It is possible for the remaining usage period to be displayed on a display unit of the reproduction apparatus so as to notify a user of changes in the remaining usage period during usage of the content.

(4) In the above embodiments, updating methods are described that allow for the remaining usage period to be reliably updated, even if malevolent acts are attempted by a user, such as suddenly turning off the power supply or disconnecting the recording medium from the content reading apparatus immediately after completing usage of the content. However, it is alternatively possible to introduce measures that lock the power supply switch key or prevent the recording medium from being disconnected from the apparatus until after completion of the update processing.

(5) The above embodiments are described in terms of content output being controlled by transmitting usage permission signal S8 from usage rights judgment unit 15 to decryption unit 14. However, it is alternatively possible to control the content output by having usage rights judgment unit 15 transmit the usage permission signal S8 to content output unit 16 rather than decryption unit 14.

Furthermore, in the above embodiments, content output to an external apparatus (e.g. a reproduction apparatus) is described as being terminated when the actual usage period exceeds the permitted usage period recorded in the recording medium as secure data. However, it is alternatively possible to terminate the operation of a unit (e.g. reproduction unit, display unit, etc) conducting reproduction and/or image display in the external apparatus when the actual usage period exceeds the permitted usage period recorded in the recording medium. In other words, usage rights judgment unit 15 may read remaining usage period S5 from protected area 23 via secure data read/write unit 12, judge whether usage of content S7 is permitted, and transmit usage permission signal S8 to the unit in the external apparatus for the duration that usage of content S7 is judged to be permitted. As a result, the usage (e.g. reproduction, image display, etc) of content S7 by the unit in the external apparatus can be restricted to the duration that usage permission signal S8 is transmitted.

(6) In the above embodiments, usage controls may be conducted by (i) providing a plurality of Rule&Key Entry areas to correspond one-to-one with the plurality of content folders, and thus if the usage period expires during the use of content in one of the content folders, the other contents in the content folder also can no longer be used, (ii) setting a single remaining usage period to correspond to a plurality of content folders, and thus if the usage period expires during the use of content in one of the content folders, contents in the other content folder also can no longer be used, and (iii) setting a plurality of remaining usage periods to correspond one-to-one with the plurality of contents in a content folder. However, it is alternatively possible to provide a calculation unit in the content reading apparatus that is operable to sum the remaining usage periods shown in two different pieces of remaining usage period information, and to control the usage restrictions based on the obtained value. As a result, the repeated use of content frequently used by the user is possible.

(7) In embodiment 2, estimated usage period z3 calculated in step 2002 may be set to the same value as remaining usage period S5 (i.e. initial value z4) in the event that z3 exceeds z4.

Estimated usage period z3 may also be set at a value designated by the content provider. Or alternatively, type-based (e.g. movies, music, etc) information relating to content continually used by the user can be maintained, and estimated usage period z3 may then set in accordance with this information. Furthermore, if content reading apparatus 1 is portable, estimated usage period z3 may be set, for example, in accordance with remaining battery power.

(8) In the above embodiments, the computer program for realizing the operations of a content reading apparatus may be stored in a storage medium, distributed on the storage medium, and then installed for use in a content reading apparatus.

### INDUSTRIAL APPLICABILITY

The present invention is particularly applicable as an apparatus for reading digital information such as image information and audio information recorded on a recording medium.

1. A content reading apparatus comprising:
a content reading unit operable to read a content from a recording medium that has recorded thereon the content and a piece of remaining usage period information showing a remaining usage period of the content, the recording medium including an authentication circuit for authenticating the content reading apparatus when the recording medium is connected thereto, and a protected area in which the remaining usage period information is recorded and which is accessible by the content reading apparatus only when the content reading apparatus has been authenticated by the authentication circuit;
a remaining usage period information reading unit operable to read the remaining usage period information from the recording medium;
a content output unit operable to output the read content to an external apparatus; and
an output termination unit operable to terminate the content output if an elapsed period from a start of the content output is equal to or exceeds the remaining usage period shown in the read remaining usage period information.

2. The content reading apparatus of claim 1, further comprising:
an update unit operable to update the remaining usage period information so as to show the remaining usage period as being less than the difference between the remaining usage period shown in the remaining usage period information prior to the updating and an output period from the start of the content output until a time of the updating, wherein
the output termination unit terminates the content output when the elapsed period from the start of the content output is equal to or exceeds the remaining usage period shown in the remaining usage period information prior to the updating.

3. The content reading apparatus of claim 2, wherein
the update unit updates the remaining usage period information so as to show the remaining usage period as having a zero value, and at a completion of the content output, reupdates the remaining usage period information based on an output period from the start until the completion of the content output.

4. The content reading apparatus of claim 2, wherein
the update unit updates the remaining usage period information before a completion of a predetermined period of content output so as to show the remaining usage period as the difference between the remaining usage period shown in the remaining usage period information prior to the updating and the predetermined period of content output, and at a completion of the content output, reupdates the remaining usage period information based on an output period from the start until the completion of the content output.

5. The content reading apparatus of claim 1, further comprising:
an update unit operable to update the remaining usage period information for every lapse of a predetermined update period so as to show the remaining usage period as being the difference between the remaining usage period shown in the remaining usage period information prior to the updating and the predetermined update period, wherein
the output termination unit terminates the content output when the elapsed period from the start of the content output is equal to or exceeds the remaining usage period shown in the remaining usage period information prior to the updating.

6. The content reading apparatus of any of claims 3 to 5 further comprising:
a termination instruction reception unit operable to receive an instruction from a user to terminate the content output, wherein
the output termination unit terminates the content output when a termination instruction is received by the termination instruction reception unit, even if the elapsed period since the start of the content output is less than the remaining usage period shown in the read remaining usage period information, and
the update unit reupdates, at a time of the reception of the termination instruction from the user, the remaining usage period information based on an output period from the start of the content output until the reception of the termination instruction.

7. The content reading apparatus of claim 1, wherein
the recording medium has recorded thereon a plurality of contents and plural pieces of remaining usage period information that correspond one-to-one with the plurality of contents, and
the output termination unit terminates the content output if the elapsed period from the start of the content output is equal to or exceeds the remaining usage period shown in a corresponding piece of remaining usage period information.

8. The content reading apparatus of claim 1, wherein
the recording medium has recorded thereon a plurality of contents and plural pieces of remaining usage period information that correspond (i) one-to-one with the plurality of contents, (ii) to a selected plurality of the contents, or (iii) one-to-one with the plurality of contents and to a selected plurality of the contents,
the content reading apparatus further comprises:
a remaining usage period calculation unit operable to sum a remaining usage period shown in one piece of remaining usage period information and a remaining usage period shown in another piece of remaining usage period information.

9. The content reading apparatus of claim 1, wherein
the recording medium has recorded thereon a plurality of contents and plural pieces of remaining usage period information that correspond one-to-one with the plurality of contents,
the plurality of contents is recorded on the recording medium in encrypted form,
the recording medium has further recorded thereon a plurality of decryption keys that correspond one-to-one with the encrypted contents,
the content reading apparatus further comprises:
a decryption unit operable to decrypt each encrypted content using the decryption key corresponding to the encrypted content, and
the content output unit outputs the decrypted content to the external apparatus.

10. The content reading apparatus of claim 1, wherein
the recording medium includes a user area that has recorded therein the plurality of encrypted contents,
a plurality of decryption keys corresponding one-to-one with the plurality of encrypted contents are recorded in the protected area together with plural pieces remaining usage period information corresponding one-to-one with the plurality of encrypted contents,
the content reading apparatus further comprises:
a decryption unit operable to decrypt each encrypted content using the decryption key corresponding to the encrypted content, and
the content output unit outputs the decrypted content to the external apparatus.

11. A content reproduction apparatus comprising:
a content reading unit operable to read a content from a recording medium that has recorded thereon the content and a piece of remaining usage period information showing a remaining usage period of the content, the recording medium including an authentication circuit for authenticating the content reproduction apparatus when the recording medium is connected thereto, and a protected area in which the remaining usage period information is recorded and which is accessible by the content reproduction apparatus only when the content reproduction apparatus has been authenticated by the authentication circuit;
a remaining usage period information reading unit operable to read the remaining usage period information from the recording medium;
a reproduction unit operable to reproduce the read content; and
a reproduction termination unit operable to terminate the content reproduction if an elapsed period from a start of the content reproduction is equal to or exceeds the remaining usage period shown in the read remaining usage period information.

12. A computer program for having a content reading apparatus that includes a CPU control a content output, comprising:
a content reading step of reading a content from a recording medium that has recorded thereon the content and a piece of remaining usage period information showing a remaining usage period of the content, the recording medium including an authentication circuit for authenticating the content reading apparatus when the recording medium is connected thereto, and a protected area in which the remaining usage period information is recorded and which is accessible by the content reading apparatus only when the content reading apparatus has been authenticated by the authentication circuit;
a remaining usage period information reading step of reading the remaining usage period information from the recording medium;
a content output step of outputting the read content to an external apparatus; and
an output termination step of terminating the content output if an elapsed period from a start of the content output is equal to or exceeds the remaining usage period shown in the read remaining usage period information.

13. A computer-readable storage medium storing a computer program for having a content reading apparatus that includes a CPU control a content output, the computer program comprising:
a content reading step of reading a content from a recording medium that has recorded thereon the content and a piece of remaining usage period information showing a remaining usage period of the content, the recording medium including an authentication circuit for authenticating the content reading apparatus when the recording medium is connected thereto, and a protected area in which the remaining usage period information is recorded and which is accessible by the content reading apparatus only when the content reading apparatus has been authenticated by the authentication circuit;
a remaining usage period information reading step of reading the remaining usage period information from the recording medium;
a content output step of outputting the read content to an external apparatus; and
an output termination step of terminating the content output if an elapsed period from a start of the content output is equal to or exceeds the remaining usage period shown in the read remaining usage period information.
